(19) United States
(12) Patent Application Publication
(10) Pub. No.: US 2023/0019831 A1
(43) Pub. Date: Jan. 19, 2023

(54) MONITORING UNIT AND METHOD FOR MONITORING THE RESOURCES BEING USED BY DRIVERS OF A DEVICE ACCESS DEVICE

(71) Applicant: Endress+Hauser Process Solutions AG, Reinach (CH)

(72) Inventors: Michael Mayer, Oberwil (CH); Wolfgang Höferlin, Efringen-Kirchen (DE)

(21) Appl. No.: 17/757,583

(22) PCT Filed: Dec. 1, 2020
(86) PCT No.: PCT/EP2020/084087

§ 371 Date: Jun. 17, 2022

(30) Foreign Application Priority Data
Dec. 19, 2019 (DE) 10 2019 135 293.2

(51) Int. Cl. G05B 19/4155

(52) U.S. Cl. CPC G05B 19/4155; G05B 2219/31135

(57) ABSTRACT

A device access means for accessing fieldbus components of a fieldbus system is described. The device access means is installed in a host or host environment and includes a frame application as well as, bound into the frame application, at least one driver, which is designed to access at least one fieldbus component. Moreover, the device access means includes a monitoring unit, which is designed to register information concerning resources reserved by drivers and provided by the operating system of the host or host environment, and, upon detecting an abnormal temporal increase of resources reserved by drivers, to initiate at least one predetermined countermeasure.

The invention relates to a device access means for accessing fieldbus components of a fieldbus system. Furthermore, the invention relates to an automation system. Moreover, the invention relates to a method for monitoring operation of a device access means.

In automation technology, field devices are often applied, which serve for registering and/or influencing process variables. Examples of such field devices are fill level measuring devices, mass flow measuring devices, pressure- and temperature measuring devices, etc., which, as a sensors, register the corresponding process variables, fill level, flow, pressure, and temperature.

For accessing fieldbus components of a fieldbus system, a large number of drivers are required, which are placed in a frame application. These drivers are, as a rule, delivered by the manufacturers with the fieldbus components. It has been found that drivers delivered by manufacturers are of varied software quality and can during operation bring about problems, which can lead to a system crash.

It is an object of the invention to enable durable operation of a device access means.

The object is achieved by features set forth in claims 1, 14 and 15.

Advantageous further developments of the invention are set forth in the dependent claims.

A device access means corresponding to the forms of embodiment of the invention serves for accessing fieldbus components of a fieldbus system. The device access means is installed in a host or a host environment and includes a frame application and, bound into the frame application, at least one driver, which is designed to access at least one fieldbus component. The device access means includes a monitoring unit, which is designed to register information concerning resources reserved by drivers and provided by the operating system of the host or host environment, and, upon detecting an abnormal temporal increase of resources reserved by drivers, to initiate at least one predetermined countermeasure.

Bound in a frame application are, as a rule, a plurality of different drivers, wherein the fieldbus components of the fieldbus system can be accessed by means of such drivers. By means of such drivers, fieldbus components can be configured and parametered, in addition, for example, a monitoring of device condition is possible. Provided for each fieldbus component of the fieldbus system is, in the normal case, a dedicated driver, which is, as a rule, delivered by the manufacturer of the fieldbus component. This leads to the fact that, as a rule, drivers from different manufacturers are bound into the frame application. It has been found that not all drivers delivered from manufacturers of fieldbus components satisfy usual programming quality standards. It has been found that problems especially arise, when a driver reserves resources provided by the operating system and then does not free these resources up after their use. Resources claimed by drivers can be, for example, memory space, handles, threads or network connections as well as other resources provided by the operating system of the host or host environment. When such resources are not freed-up after their use, an abnormal increase of the resources claimed by drivers occurs. An abnormal increase means especially, for example, an increase of reserved resources brought about by disregarding usual programming standards. Such can lead to a loss of performance, especially to a slowing of the operation of the device access means. Moreover, a steadily increasing claiming of resources can also bring about a crash of the operating system of the host or host environment.

In order to detect such problems early, there is provided in the device access means a monitoring unit, which monitors resources claimed by drivers. For this, the monitoring unit can be designed, for example, to retrieve from the operating system of the host or host environment and to follow as a function of time, parameters, which reflect resource reservation. When the monitoring unit detects an abnormal increase of resources claimed by the drivers, the monitoring unit can initiate suitable countermeasures. For example, the monitoring unit can inform the user of the problem, contact a support facility, such as a support team, initiate a reinstallation of the driver e.g. an updated version of the driver, initiate a reboot of the host or host environment, perform a memory dump, etc. Countermeasures initiated by the monitoring unit can prevent losses of performance of the device access means as well as system crashes. This increases customer acceptance. Moreover, it is possible to detect poorly programmed drivers and to prompt their manufacturers to remove the problems. By these measures, the software quality of the device access means is durably improved, such that a stable operation of the device access means is enabled.

A system of automation technology corresponding to the forms of embodiment of the invention includes a fieldbus system having at least one fieldbus component as well as a device access means, which is installed in a host or a host environment. The device access means includes a frame application and, bound into the frame application, at least one driver, which is designed to access at least one fieldbus component of the fieldbus system. The system includes a monitoring unit, which is designed to register information concerning resources reserved by drivers and provided by the operating system of the host or host environment, and upon detecting an abnormal temporal increase of resources reserved by drivers to initiate at least one predetermined countermeasure.

A method corresponding to the forms of embodiment of the invention serves for monitoring operation of a device access means, which is installed in a host or a host environment. The device access means is designed to access fieldbus components of a fieldbus system. The device access means includes a frame application and at least one driver bound into the frame application and designed to access at least one fieldbus component of the fieldbus system. The method includes registering information concerning resources reserved by drivers and provided by the operating system of the host or host environment, evaluating a temporal course of resources reserved by drivers and, in the case of ascertaining an abnormal temporal increase of resources reserved by drivers, initiating at least one predetermined countermeasure.

The invention will now be explained in greater detail based on examples of embodiments shown in the appended drawing. The figures of the drawing show as follows:

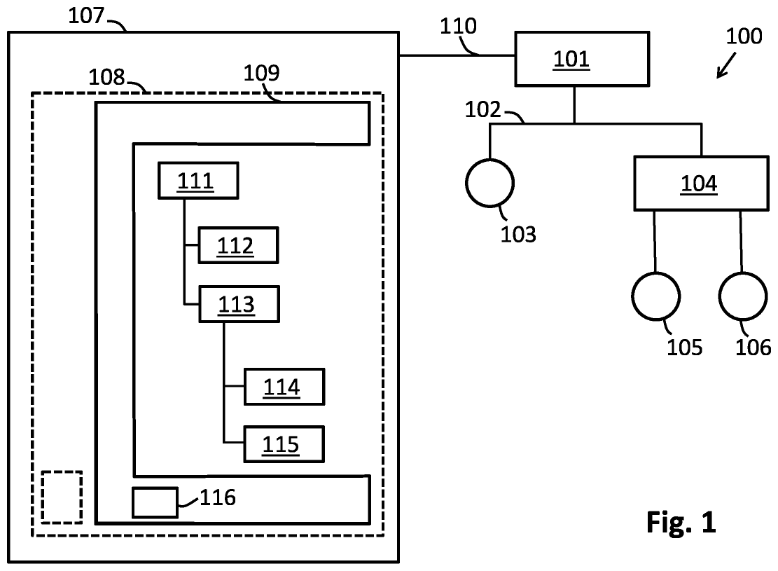

FIG. 1 the structure of a fieldbus network and an associated device access means in the form of a device access software with drivers bound therein;

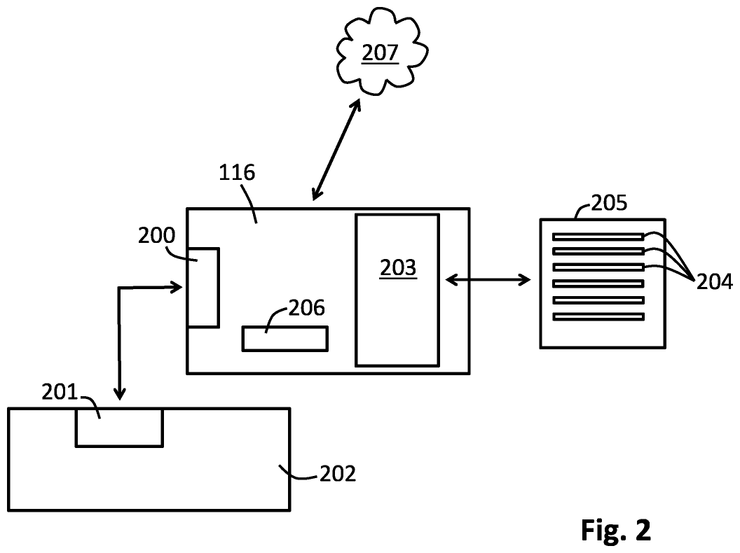

FIG. 2 a schematic view of a monitoring system, which is designed to retrieve information from a debugging interface of an operating system; and

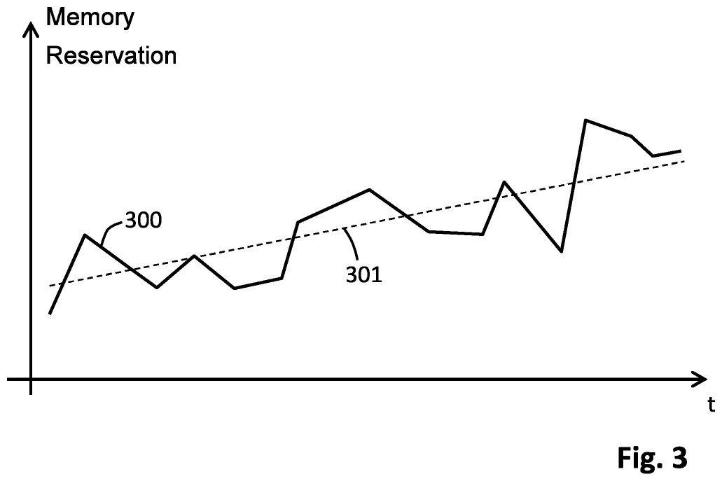

FIG. 3 a graph as a function of time showing on average a steady increase of claimed memory.

FIG. 1 shows a fieldbus network 100, which comprises a plurality of field devices and gateway devices. Located at the uppermost hierarchy level of the fieldbus network 100 is a field entry device 101. Field entry device 101 is connected, for example, via a PROFIBUS segment 102, with a field device 103 and a gateway device 104. The PROFIBUS segment 102 is coupled via the gateway device 104 with the HART field devices 105 and 106, wherein the gateway device 104 is designed to convert the data traffic from the PROFIBUS protocol into the HART protocol and vice versa.

The parametering, configuration and condition monitoring of the field devices of a fieldbus network occurs by means of a device access software 108 installed in a host 107 and comprising a frame application 109. Host 107 is connected with the fieldbus network 100 via an Ethernet connection 110. The various components of the fieldbus network 100 can be accessed via the device access software 108. Especially via the device access software 108, the parameters of the different components of the fieldbus network 100 can be read-out, displayed and changed. Moreover, the device access software 108 permits a condition monitoring of the components of the fieldbus network 100. The data exchange required for these tasks is, as a rule, conducted via the so-called acyclic data traffic.

In order to be able correctly to access the different components of the fieldbus network 100, the frame application 109 requires information concerning properties and parameters of the field devices, gateways, remote I/Os, etc. of the fieldbus network 100. This information is provided by the manufacturers of the different devices, as a rule, in the form of device drivers, or device description files. Used for device description for acyclic data exchange in the case of the fieldbus protocols PROFIBUS-DP, PROFIBUS-PA, FOUNDATION Fieldbus and HART are device descriptions according to the standards DTM (Device Type Manager), DD (Device Description), EDD (Enhanced Device Description) as well as FDI Device Packages. Especially in the case of the standards EDD and DTM, supplementally to device parameters, device functionality and address space allocation, also graphical features and graphical user interfaces are predetermined for the purpose of facilitating the parametering and configuring of field devices. For producing these graphical interfaces in the standard EDD, special graphical commands are provided, which are processed in the manner of an interpreter language.

In the standard FDT/DTM, the DTMs (Device Type Manager) are provided in the form of dynamically loadable libraries (DLLs) or in the form of executable files (executables). A DTM includes also the mentioned graphical features. The different DTMs for the different components of the fieldbus network are bound into a shared FDT frame application, wherein FDT stands for “Field Device Tool”. Thus, a shared frame application is provided, into which the DTMs of different devices and from different manufacturers can be bound. The FDT standard has in the last years increasingly been supplemented and will later possibly be replaced by the standard FDI Device Packages.

Besides the previously discussed fieldbus protocols, PROFIBUS, FOUNDATION Fieldbus and HART, the so-called industrial Ethernet protocols can also be mentioned, to which, among others, the fieldbus protocols, EtherNet/IP, PROFINET and EtherCAT belong. In the case of the fieldbus protocol, EtherNet/IP, a device description file corresponding to the standard EDS (Electronic Data Sheet) is provided for describing both cyclic as well as also acyclic data exchange.

In the example of FIG. 1, the device access software 108 preferably comprises a frame application 109 of the standard, FDT (Field Device Tool), wherein different drivers for the different devices and components of the fieldbus network 100 can be bound into the frame application 109. Bound into an FDT frame application can be, for example, different Device Type Managers (DTMs) from different manufacturers. Besides DTMs, also other device description files can be bound into the frame application 109. In such case, the hierarchical structure of the fieldbus network 100 is mimicked within the device access software 108 with the help of drivers, or device description files, wherein the arrangement of the drivers, or device description files, corresponds, in such case, to mirror images of the structure of the fieldbus network 100. For accessing the components of the fieldbus network 100, for example, a number of different device DTMs, gateway DTMs and communication DTMs can be bound into a frame application 109. At the uppermost position of the DTM hierarchy is the communication DTM 111. The communication DTM 111 corresponds to the field entry device 101 and communicates with such over the Ethernet connection 110. The communication DTM 111 represents the external interface of the device access software 108, wherein all in- and outgoing data traffic passes through the communication DTM 111.

The device DTM 112 is arranged in the DTM hierarchy below the communication DTM 111. The device DTM 112 maps the functionality of the field device 103. Also arranged at the level below the communication DTM 111 is a gateway DTM 113, which corresponds to the gateway 104. Via the gateway DTM 113, the gateway 104 can be parametered and configured. Arranged beneath the gateway DTM 113 in the DTM hierarchy are two device DTMs 114, 115. Via the device DTMs 114, 115, the field devices 105, 106 can be accessed. Besides the standard, FDT/DTM, there are a large number of alternative standards for the device access software 108 and the device drivers bound therein.

Based on information retrieved from the DTMs for the individual devices, the FDT frame application can graphically display to the user, preferably in the form of a tree structure, the hierarchical structure of the fieldbus network 100.

The fieldbus network 100 can, for example, comprise fieldbus components of different manufacturers. The manufacturer of a fieldbus component, as a rule, provides the driver for the fieldbus component, such that in the normal case drivers of different manufacturers are bound into the frame application 109. It has been found that these drivers can be of very different software quality. A poor programming quality of a driver is present, for example, when the driver claims resources provided by the operating system, and, after using the resources, fails to properly free them up. Such a behavior leads to a steadily increasing resource consumption by the driver.

The resources provided by the operating system can be, for example, memory space, handles, threads or data traffic emanating from the driver. These resources are managed by the operating system, which, consequently, also performs their reserving and freeing up.

A first example of resources provided by the operating system is memory space. For example, the driver could comprise a table, into which new entries are inserted during operation. When the memory space allocated for the entries, contrary to good programming rules, is not freed up after use, the size of the memory space allocated for the table steadily increases, this leading, after some time, to a crash of the operating system.

Another example of resources provided by the operating system is the handles for graphical display elements, the so-called GUI-handles, wherein GUI stands for “Graphical User Interface”. When a driver reserves such handles and after use does not properly free them up, then the number of handles reserved by the drivers rises steadily during operation. Since, however, the number of handles allocatable by the operating system is limited, also the increasing number of handles leads unavoidably to a crash of the operating system.

Threads are a further example of resources provided by the operating system. Referred to as a thread is an execution thread, thus, a sequential course of processing within a process. In such case, each thread, i.e. program thread, is responsible for performing a certain task. The execution threads of the program functions can in this way be divided into manageable units. A process can comprise a plurality of threads or, when in the case of a program execution no parallel processing is provided, also only a single thread. Threads share within a process processors, memories and other operating system dependent resources, such as files and network connections. Therefore, managing effort for threads is usually less than that for processes. An essential efficiency advantage of threads is that, on the one hand, in contrast to processes, in the case of thread alternation, no complete alternating of the process context is necessary, since all threads use a shared part of the process context. On the other hand, there is easy communication and fast data exchange between threads. In the case of threads, it can occur that a driver starts a plurality of threads, which are not properly ended after their execution. In such case, the number of threads started by the drivers steadily increases. Since the operating system can only manage a limited number of threads, this also can lead to a crash of the operating system.

Another example of a resource claimed by a driver is the network traffic outwardly directed from the driver. When a driver is so programmed that the outwardly directed network traffic continually increases, also this will lead after a certain time to problems and, in given cases, to a system crash.

In order to detect and overcome such problems brought about by improperly programmed drivers and ever increasing resource consumption, the device access software 108 according to the forms of embodiment of the invention includes a monitoring unit 116, which is designed to monitor resources reserved by the drivers, to detect an abnormal increase of resource reservation and in the case of such an increase to initiate countermeasures. In the case of the form of embodiment shown in FIG. 1, the monitoring unit 116 is embodied as part of the frame application 109. Alternatively thereto, it would be possible to implement a monitoring unit as part of the device access software 108, however, as a unit separate from the frame application 109, such as shown dashed in FIG. 1.

FIG. 2 shows the monitoring unit 116, which is designed to detect an excessive and abnormal claiming of resources by drivers bound into the device access software 108. For this, the monitoring unit 116 includes a data interface 200, via which it can access a debugging interface 201 of the operating system 202. The debugging interface 201 can be, for example, the Windows debugging interface provided by the Windows operating system. Via the debugging interface 201, the monitoring unit 116 can retrieve parameters of the operating system, especially parameters, which show current resource reservations of the operating system with reference to memory space, handles, threads and outwardly directed network traffic. The parameters retrievable by the monitoring unit 116 via the debugging interface 201 and the data interface 200 can be, for example, the memory space claimed by the drivers, the number of handles awarded, the number of active threads or the data rate of the outwardly directed network traffic.

The fetching and evaluation of selected parameters are controlled by a sequence of commands of a command language. For this, the monitoring unit 116 includes an interpreter unit 203, which is designed to process a sequence of commands 204 of a command language. The commands 204 can be provided in the form of a script 205, for example. The commands 204 can comprise, for example, looping commands, in order to retrieve selected parameters at regular time intervals via the debugging interface 201 from the operating system 202. The so registered parameter values can, for example, be stored in the monitoring unit 116. In this way, parameters, which reflect the resource reservations of the drivers, can be registered as functions of time and followed, in order, in this way, to be able to monitor resource reservations.

Plotted in FIG. 3 is a curve 300, which displays the value of a parameter representing the memory reserved by drivers as a function of time. It can be seen that memory reservation is subjected to temporal fluctuations as a result of the activities of the individual drivers, wherein, however, supplementally to these fluctuations a steadily rising memory reservation is present, which is shown in FIG. 3 by the dashed line 301. The on average steadily rising amount of memory claimed by drivers shows that at least one driver is present, which is abnormally not freeing-up once claimed memory space. With the steady increase of the memory reservation shown in FIG. 3, a durably stable operation of the device access software 108 in the host 107 is not possible. Rather, after a certain time, a crash of the operating system is to be expected. Also, in the case of other resources provided by the operating system, such as, for example, the number of handles, the number of threads, as well as the bandwidth of the outwardly directed network traffic, a steady increase with time shows that claimed resources of the operating system are not being properly freed up, this leading in turn to foreseeable problems also in the case of these examples.

For evaluating the parameters retrieved from the debugging interface 201 of the operating system 202, there is provided in the monitoring unit 116 an evaluation unit 206, which is designed to follow the retrieved parameter as a function of time and to detect an abnormal increase of reserved resources of the operating system. For this, the evaluation unit 206 can, for example, record a parameter as a function of time and based on this then analyze, whether an abnormal temporal increase is present or not. For example, the evaluation unit 206 can detect for this, whether or not the temporal increase of the parameter exceeds a predetermined limit value.

When the evaluation unit 206 determines that an abnormal temporal increase of the claimed resources of the operating system 202 by the drivers is present, then the evaluation unit 206 ascertains in a second step, which of the drivers bound into the frame application 109 is responsible for the abnormal increase in claimed resources. For this, the evaluation unit 206 can follow, for example, which of the drivers claims memory space, requests handles, starts threads or causes network traffic. In this way, it is possible to identify the one or more drivers responsible for the abnormal increase of the reserved resources. In this way, the underlying problem can be located, before a system crash occurs. Insofar, the monitoring unit 116 can be considered to be an automated debugging unit, which performs continuous system monitoring during ongoing operation.

When the monitoring unit 116 detects a problem relative to the claiming of resources by the drivers, it can initiate one or more suitable countermeasures. In the following, some possible countermeasures will now be discussed. The countermeasures described in the following can, in each case, also be used in any combination.

One possible countermeasure is to indicate to the user on a display or other suitable display unit, for example, also by means of a report transmitted to a mobile device, that there is a problem of an increasing claiming of resources by the drivers. The user can, for example, be told that the memory requirement of the system, the number of used handles, the number of started threads or the outwardly directed network traffic is trending upwards. Additionally, the user can be shown a prognosis, when in view of the progressing resource consumption a system crash is to be expected. The user can then estimate, how much time remains for solving the problem. Additionally, also information for identifying the abnormally working driver can be displayed.

Another possible countermeasure is to forward, for example, per E-mail, information concerning the problem automatically to a support facility, for example a support team. Such a support team can be operated, for example, by the producer of the frame application or a field device manufacturer. Alternatively thereto, a producer association or a producer-overarching organisation can maintain a support team. After receiving a problem report, members of the support team can then, for example, get in touch with the user and provide information on how to solve the problem. Alternatively or supplementally thereto, the members of the support team can per remote access interact with the host and eliminate the problem. For example, the members can per remote access perform a reinstallation of the problem driver, install an updated version of the driver or reboot the system.

Especially advantageously, the problem reports on problems caused by drivers are transmitted to a central facility, for example, to a producer association or other producer-encompassing organisation, which receives the problem reports from a large number of users. By evaluating the problem reports, it can especially be found out, which drivers are abnormally claiming resources. In such case, the producers of the affected drivers can be contacted and requested to provide corrected driver versions.

Another possible countermeasure in the case of a problem caused by excessive claiming of resources is to write information concerning the problem from the monitoring unit 116 into a cloud 207, wherein the problem reports from different fieldbus systems are collected in the cloud 207. Based on the problem reports collected in the cloud 207, then an evaluation can be performed, in order to ascertain, which drivers of which manufacturers frequently cause problems relative to an abnormal claiming of resources. The guilty manufacturers can then be requested to provide corrected versions of the relevant drivers, in order to enable reliable operation of the device access software 108.

Another possible countermeasure after detecting a superelevated claiming of resources by a driver is to reinstall the relevant driver or to install an updated version of the driver. With a reinstallation of the driver, it can at least be assured that the reserved resources are freed up, such that a system crash is prevented. The installation of a newer version of the driver offers, in contrast, a chance that the newer version of the driver works properly, such that the problems caused by the driver relative to steadily increasing claiming of resources are no longer present. In order to ascertain, whether a more recent version of the relevant driver exists, the monitoring unit 116 can, for example, compare the version of the presently installed driver with the version of the newest driver available for the relevant fieldbus component. For the reinstallation of the existing driver or a more recent version of the driver, there is, on the one hand, the opportunity that user be led step by step through the installation process by means of prompts provided for this. At the end of the installation process, it can, for example, be displayed to the user that the reinstallation of the driver or the installation of a more recent version of the driver was successfully accomplished. Alternatively, the monitoring unit 116 can after detecting a problem relative to the claiming of resources by a driver automatically initiate a reinstallation of the relevant driver, or install a more recent version of such driver, or bring about such an installation. After finishing the installation, it can be displayed to the user, for example, that a reinstallation or an installation of a more recent version was successfully accomplished.

As another possible countermeasure, it can be provided that the monitoring unit 116 after detecting an abnormally working driver initiates a reboot of the host 107. In this way, the reserved resources back are freed up, such that an unexpected system crash is prevented.

In an additional possible countermeasure, upon detecting an abnormal claiming of resources by at least one of the drivers, a memory dump can be automatically performed, in the case of which the memory is completely or partially saved. Such a memory dump can be useful both for analyzing what went wrong as well as also for recovering otherwise lost information.

Problems relative to an excessive claiming of resources by at least one driver can especially lead to crashes during the execution of a system scan, because during the system scan the drivers for all fieldbus components are addressed or installed. When individual drivers do not free-up once claimed resources, this can lead to a crash of the operating system during the system scan. This is true especially, but not only, for large fieldbus systems having a large number of fieldbus components. For preventing such a system crash, the monitoring unit 116 can be designed to suggest to the user to break the system scan into a plurality of smaller, partial scans. Alternatively thereto, the monitoring unit 116 can be designed to break the scan automatically into a plurality of sequentially performed, partial scans.

1-16. (canceled)

17. A device access means for accessing fieldbus components of a fieldbus system, wherein the device access means is installed in a host or a host environment, the device access means comprising:
a frame application; and,
at least driver bound into the frame application, wherein the at least one driver is designed to access at least one fieldbus component,
wherein the device access means includes a monitoring unit designed to register information concerning resources reserved by drivers and provided by the operating system of the host or the host environment, and, upon detecting an abnormal temporal increase of resources reserved by drivers, to initiate at least one predetermined countermeasure.

18. The device access means as claimed in claim 17, wherein the resources registered by the monitoring unit include at least one of the following: memory space reserved by drivers, a number of handles reserved by drivers, a number of threads started by drivers, and an extent of network traffic caused by drivers.

19. The device access means as claimed in claim 18, characterized by at least one of the following:
the monitoring unit is designed to retrieve from the host or host environment parameters, which show resources reserved by drivers and provided by the operating system;
the monitoring unit is designed to retrieve from the host or host environment via a debugging interface of the operating system parameters, which show resources reserved by drivers and provided by the operating system; and
the monitoring unit is designed to retrieve from the host or host environment according to a predetermined time schema parameters, which show resources reserved by drivers and provided by the operating system.

20. The device access means as claimed in claim 19, characterized by at least one of the following:
the monitoring unit is designed based on registered information to ascertain reservation of resources by drivers as a function of time;
the monitoring unit is designed based on parameters retrieved from the operating system of the host or host environment to ascertain reservation of resources by drivers as a function of time;
the monitoring unit is designed based on a predefined criterion to detect an abnormal temporal increase of the resources reserved by drivers; and
the monitoring unit is designed to compare a temporal increase of resources reserved by drivers with a predetermined threshold value.

21. The device access means as claimed in claim 20, wherein the monitoring unit is designed to ascertain in a first step whether resources reserved by the drivers show an abnormal temporal increase, and, when reserved resources show an abnormal temporal increase, to identify in a second step at least one driver responsible for the abnormal temporal increase of reserved resources.

22. The device access means as claimed in claim 21, characterized by at least one of the following:
the monitoring unit is designed to follow memory space reserved by drivers;
the monitoring unit is designed to follow number of handles reserved by drivers;
the monitoring unit is designed to follow number of threads started by drivers; and
the monitoring unit is designed to follow extent of network traffic caused by drivers.

23. The device access means as claimed in claim 22, characterized by at least one of the following:
the monitoring unit is designed to ascertain, whether an abnormal temporal increase of memory space reserved by drivers is present and, for the case, in which an abnormal temporal increase is present, which to identify at least one driver, which is responsible for the abnormal temporal increase of reserved memory space;
the monitoring unit is designed to ascertain, whether an abnormal temporal increase of number of handles reserved by drivers is present and, for the case, in which an abnormal temporal increase is present, which to identify at least one driver, which is responsible for the abnormal temporal increase of the number of handles reserved by drivers;
the monitoring unit is designed to ascertain, whether an abnormal temporal increase of the number of threads started by drivers is present and, for the case, in which an abnormal temporal increase is present, to identify at least one driver, which is responsible for the abnormal temporal increase of number of threads started by drivers; and
the monitoring unit is designed to ascertain, whether an abnormal temporal increase of extent of network traffic caused by drivers is present and, for the case, in which an abnormal temporal increase is present, to identify at least one driver, which is responsible for the abnormal temporal increase of network traffic.

24. The device access means as claimed in claim 23, characterized by at least one of the following:
the monitoring unit includes an interpreter unit which is designed to process a sequence of instructions; and
the monitoring unit includes an interpreter unit which is designed to process a sequence of instructions according to a predetermined script.

25. The device access means as claimed in claim 24, characterized by at least one of the following:
the instructions are designed to control retrieval of parameters from the operating system of the host or host environment, parameters which show reservation of resources by drivers;
the instructions are designed to control evaluation of resources reserved by drivers as a function of time;
the instructions are designed to control evaluation of parameters retrieved from the operating system of the host or host environment as a function of time; and
the instructions include looping commands which are designed to control a periodic retrieval of parameters from the operating system of the host or host environment, parameters which show reservation of resources by drivers.

26. The device access means as claimed in claim 25, characterized by at least one of the following:
the monitoring unit is embodied as an automated debugging unit;
the monitoring unit is embodied automatically to follow reservation of resources by the at least one driver; and
the monitoring unit includes an interface to a debugging interface of the operating system via which debugging interface parameters, which show reservation of resources by drivers, can be retrieved.

27. The device access means as claimed in claim 26, characterized by one of the following:
the monitoring unit is embodied as part of the frame application; and
the monitoring unit is embodied as a unit provided supplementally to the frame application.

28. The device access means as claimed in claims 27, characterized by at least one of the following:
bound into the frame application are drivers corresponding to one or more of the following standards: Field Device Tool (FDT)/Device Type Manager (DTM), Device Description (DD), Enhanced Device Description (EDD), Electronic Data Sheet (EDS), Field Device Integration (FDI) Device Packages; and
the frame application is an FDT frame application or an FDI frame application and bound into the FDT frame application or FDI frame application are drivers of the standards, FDT/DTM and/or FDI Device Packages.

29. The device access means as claimed in claim 28, characterized in that the at least one predetermined countermeasure comprises at least one of the following:
the user is shown on a display that an abnormal temporal increase of resources reserved by drivers is present;
the user is shown on a display the at least one driver, which is causing the abnormal temporal increase of the reserved resources;
the user is shown on a display a prognosis of when, in view of the abnormal temporal increase of the reserved resources, a crash of the operating system is to be expected;
electronically reporting to a support facility;
reinstalling a driver responsible for an abnormal temporal increase of reserved resources;
remotely accessing a support instance in the host or host environment for removing problems caused by reservation of resources by drivers;
electronically reporting to a central instance, which is designed to receive and to evaluate driver problem reports of a plurality of fieldbus systems;
writing information concerning abnormal temporal increase of resources reserved by drivers into a cloud, wherein in the cloud information concerning problems with drivers from a plurality of fieldbus systems are collected and evaluated;
in the case of a driver responsible for an abnormal temporal increase of reserved resources, ascertaining whether the installed version of the driver is outdated, and, when the installed version of the driver is outdated, leading the user through an installation of a current version of the driver;
in the case of a driver responsible for an abnormal temporal increase of reserved resources, ascertaining whether the installed version of the driver is outdated, and, when the installed version of the driver is outdated, automatically initiating an installation of a current version of the driver;
rebooting the host or host environment; and
initiating a memory dump of at least a part of memory of the host or host environment.

30. A system of automation technology, comprising:
a fieldbus system having at least one fieldbus component; and
a device access means which is installed in a host or host environment, wherein the device access means includes:
a frame application; and
bound into the frame application, at least one driver which is designed to access at least one fieldbus component of the fieldbus system,
wherein the system includes a monitoring unit which is designed to register information concerning resources reserved by the drivers and provided by the operating system of the host or host environment, and to initiate at least one predetermined countermeasure upon detecting an abnormal temporal increase of resources reserved by the drivers.

31. A method for monitoring operation of a device access means which is installed in a host or host environment, wherein the device access means is designed to access fieldbus components of a fieldbus system, wherein the device access means includes:
a frame application, and
at least one driver bound into the frame application and designed to access at least one fieldbus component of the fieldbus system, the method comprising:
registering information concerning resources reserved by drivers and provided by the operating system of the host or host environment;
evaluating a temporal course of resources reserved by drivers; and
in the case of ascertaining an abnormal temporal increase of resources reserved by drivers, initiating at least one predetermined countermeasure.

32. The method as claimed in claim 31, characterized by at least one of the following steps:
retrieving parameters from the operating system of the host or host environment, parameters which show resources reserved by drivers and provided by the operating system;
ascertaining, based on parameters retrieved from the operating system of the host or host environment, resources reserved by drivers as a function of time;
detecting, based on a predefined criterion, an abnormal temporal increase of resources reserved by drivers;
comparing a temporal increase of resources reserved by drivers with a predetermined threshold value; and
ascertaining whether resources reserved by drivers show an abnormal temporal increase, and when reserved resources show an abnormal temporal increase, identifying at least one driver responsible for the abnormal temporal increase of reserved resources.
